(19) United States
(12) Patent Application Publication
(10) Pub. No.: US 2021/0256263 A1
(43) Pub. Date: Aug. 19, 2021

(54) INFORMATION PROCESSING APPARATUS, INFORMATION PROCESSING METHOD, AND PROGRAM

(71) Applicant: SONY CORPORATION, TOKYO (JP)

(72) Inventors: KENJI SUGIHARA, TOKYO (JP); MARI SAITO, TOKYO (JP)

(21) Appl. No.: 17/250,432

(22) PCT Filed: Jul. 26, 2019
(86) PCT No.: PCT/JP2019/029467

§ 371 Date: Jan. 20, 2021

(30) Foreign Application Priority Data
Jul. 31, 2018 (JP) 2018-143309

(51) Int. Cl. G06K 9/00; G02B 27/01; G06Q 30/06; G06F 3/01

(52) U.S. Cl. CPC G06K 9/00671; G02B 27/017; G02B 2027/014; G06F 3/011; G06Q 30/0643

(57) ABSTRACT

It is desirable to provide a technology making it possible to make a suggestion to a user while reducing discomfort given to the user. Provided is an information processing apparatus (10) including: an action information acquiring section (121) that acquires action information of a user; a suggestion information acquiring section (122) that acquires, on a basis of the action information, suggestion information for the user related to a surrounding environment of the user based on a timing of acquiring the action information; and a display controlling section (129) that controls, on a basis of the suggestion information, a display device to display an avatar object that performs an action based on the suggestion information in a field of view of the user.

### TECHNICAL FIELD

The present disclosure relates to an information processing apparatus, an information processing method, and a program.

### BACKGROUND ART

A technique for providing a user with an image based on user information has been recently known. For example, a technique is disclosed which provides a user with an image based on user's action information (refer to PTL 1, for example). Another technique is also known in which user information is acquired and suggestion information based on the acquired user information is provided as text data to a user.

### CITATION LIST

### Patent Literature

PTL 1: International Publication No. WO2016/157677

### SUMMARY OF THE INVENTION

### Problems to be Solved by the Invention

However, it can give discomfort to a user if suggestion information contains information that is not necessary for the user and is provided as text data. Accordingly, it is desired to provide a technique that makes it possible to make a suggestion to the user while reducing discomfort given to the user.

### Means for Solving the Problems

According to the present disclosure, there is provided an information processing apparatus including: an action information acquiring section that acquires action information of a user; a suggestion information acquiring section that acquires, on a basis of the action information, suggestion information for the user related to a surrounding environment of the user based on a timing of acquiring the action information; and a display controlling section that controls, on a basis of the suggestion information, a display device to display an avatar object that performs an action based on the suggestion information in a field of view of the user.

According to the present disclosure, there is provided an information processing method including: acquiring action information of a user; acquiring, on a basis of the action information, suggestion information for the user related to a surrounding environment of the user based on a timing of acquiring the action information; and controlling, on a basis of the suggestion information, a display device to display an avatar object that performs an action based on the suggestion information in a field of view of the user.

According to the present disclosure, there is provided a program causing a computer to function as an information processing apparatus. The information processing apparatus includes an action information acquiring section that acquires action information of a user, a suggestion information acquiring section that acquires, on a basis of the action information, suggestion information for the user related to a surrounding environment of the user based on a timing of acquiring the action information, and a display controlling section that controls, on a basis of the suggestion information, a display device to display an avatar object that performs an action based on the suggestion information in a field of view of the user.

### Effects of the Invention

According to the present disclosure described above, there is provided a technology that makes it possible to make a suggestion to a user while reducing discomfort given to the user. It is to be noted that the above-described effects are not necessarily limitative. In addition to or in place of the above effects, there may be achieved any of the effects described in the present specification or other effects that may be grasped from the present specification.

### BRIEF DESCRIPTION OF DRAWINGS

FIG. 1 is a diagram illustrating an example configuration of an information processing system according to an embodiment of the present disclosure.

FIG. 2 is a diagram illustrating an example functional configuration of an information processing apparatus.

FIG. 3 is a diagram illustrating a detailed example configuration of a control unit.

FIG. 4 is a diagram illustrating an example configuration of suggestion definition information.

FIG. 5 is a diagram illustrating an example configuration of agent definition information.

FIG. 6 is a diagram illustrating an example of agent model information corresponding to an action involving thinking.

FIG. 7 is a diagram illustrating an example configuration of agent model information corresponding to a perceptual action.

FIG. 8 is a diagram illustrating an example configuration of map information.

FIG. 9 is a diagram illustrating a first example of causing an agent to perform an action involving thinking.

FIG. 10 is a diagram illustrating a second example of causing the agent to perform an action involving thinking.

FIG. 11 is a diagram illustrating a third example of causing the agent to perform an action involving thinking.

FIG. 12 is a diagram illustrating a first example of causing the agent to perform a perceptual action.

FIG. 13 is a diagram illustrating a second example of causing the agent to perform a perceptual action.

FIG. 14 is a diagram illustrating a third example of causing the agent to perform a perceptual action.

FIG. 15 is a diagram illustrating a fourth example of causing the agent to perform a perceptual action.

FIG. 16 is a flowchart illustrating an example operation of the information processing apparatus.

FIG. 17 is a flowchart illustrating an example operation of the information processing apparatus.

FIG. 18 is a block diagram illustrating an example hardware configuration of the information processing apparatus.

### MODES FOR CARRYING OUT THE INVENTION

Hereinafter, preferred embodiments of the present disclosure are described in detail with reference to the accompanying drawings. It is to be noted that, in the present specification and drawings, repeated description is omitted for components having substantially the same functional configuration by assigning the same reference signs.

Further, in the present specification and drawings, a plurality of components having substantially the same or similar functional configuration are distinguished by adding different numbers to the ends of their reference signs in some cases. It is to be noted that only the same reference sign is assigned to a plurality of components having substantially the same or similar functional configuration in a case where there is no particular need to distinguish them. Additionally, similar components described in different embodiments are distinguished by adding different alphabet characters to the end of the same reference sign. It is to be noted that only the same reference sign is assigned to the similar components in a case where there is no particular need to distinguish them.

It is to be noted that the description is given in the following order.

### 0. Outline

### 1. Detailed Description of Embodiments

### 1.1. Example System Configuration

### 1.2. Example Functional Configuration of Information Processing Apparatus

### 1.3. Detailed Description of Functions of Information Processing System

### 1.3.1. Information to be Used for Agent Control

### 1.3.2. Control of Agent

### 1.3.3. Operation of Information Processing Apparatus

### 1.3.4. Various Modification Examples

### 2. Example Hardware Configuration

### 3. Conclusion

### 0. Outline

First, the outline of an embodiment of the present disclosure is described. A technique for providing a user with an image based on user information has been recently known. For example, a technique is disclosed which provides a user with an image based on user's action information. Another technique is also known in which user information is acquired and suggestion information based on the acquired user information is provided as text data to a user.

However, it can give discomfort to a user if suggestion information contains information that is not necessary for the user and is provided as text data. Hereinafter, a technology that makes it possible to make a suggestion to the user while reducing discomfort given to the user is mainly described.

Specifically, in the embodiment of the present disclosure, an object that performs an action based on suggestion information is displayed. This allows the suggestion information to be provided to a user indirectly via the object as compared to a case where the suggestion information is provided as text data to the user, so that it possible to make a suggestion to the user while reducing discomfort given to the user. In the following, a case is mainly assumed where an avatar object is used as an example of the object that performs an action based on the suggestion information. However, the object that performs an action based on the suggestion information should not be limited to the avatar object.

Also, in the following, the object that performs an action based on the suggestion information may be referred to as “agent”. The agent can also mean an object that performs an action in place of the user. However, the agent according to the embodiment of the present disclosure is not necessarily an object that performs an action in place of the user, and a type of a process to be performed by the agent according to the embodiment of the present disclosure is not particularly limited.

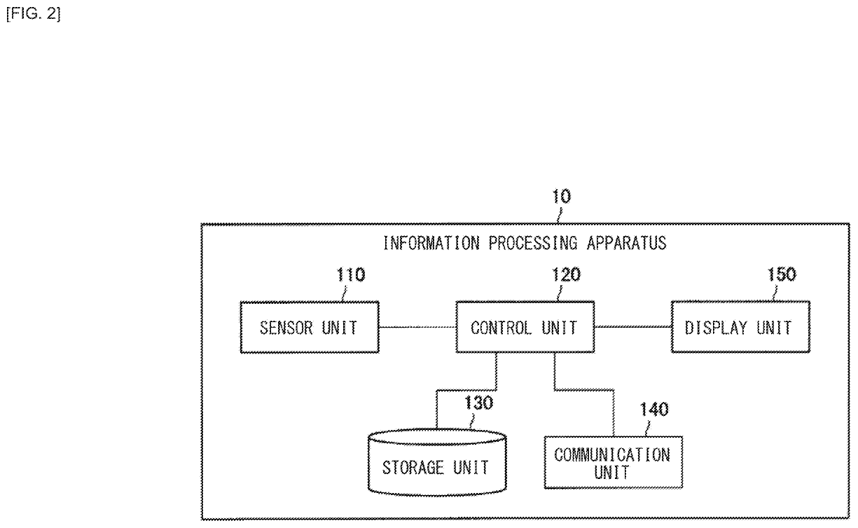

Further, in the embodiment of the present disclosure, a case is mainly described where the agent is an object (virtual object) displayed on a display area of a display unit 150 (FIG. 2). However, the agent may also be a real object that is autonomously movable. In this case, the real object may be made movable in any manner. For example, if the real object includes a rotating body (e.g., a tire, a wheel, a roller, or the like), the real object may be movable on a surface (e.g., on a floor surface) by rotatably driving the rotating body. Alternatively, if the real object includes a foot part, the real object may be movable on a surface (e.g., on a floor surface), by driving the foot part to walk.

The outline of the embodiment of the present disclosure has been described above.

### 1. Detailed Description of Embodiments

Embodiments of the present disclosure will now be described in detail.

### 1.1 Example System Configuration

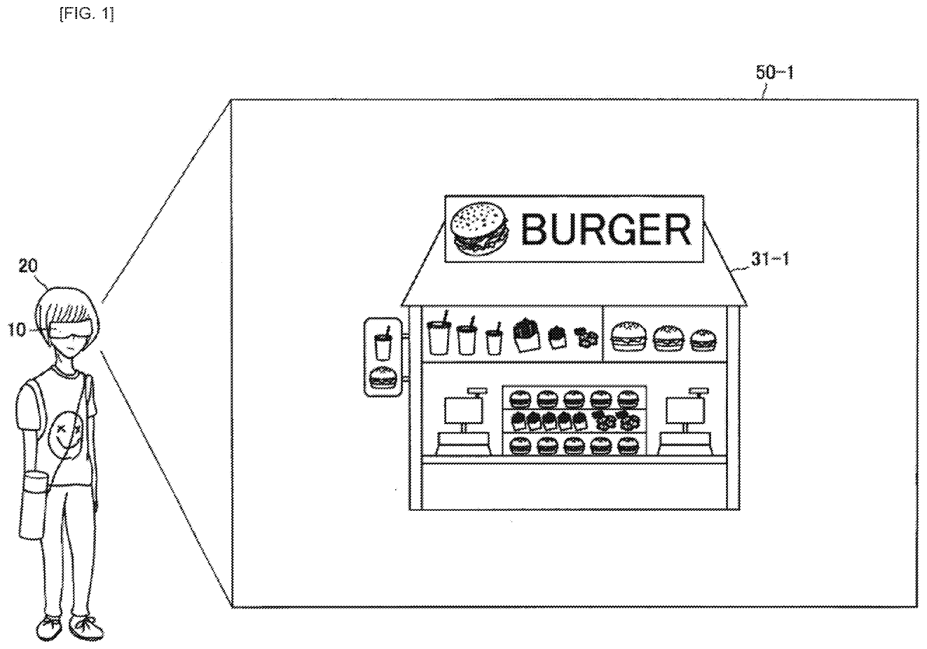

First, an example configuration of an information processing system according to an embodiment of the present disclosure will now be described with reference to the drawings. FIG. 1 is a diagram illustrating an example configuration of the information processing system according to the embodiment of the present disclosure. As illustrated in FIG. 1, the information processing system according to the embodiment of the present disclosure includes an information processing apparatus 10. The information processing apparatus 10 is used by a user 20.

It is to be noted that mainly described in this embodiment is a case where the information processing apparatus 10 is a head mounted display (HMD) to be worn on the head of the user 20. In a case where the information processing apparatus 10 is an HMD, it is possible to easily move the field of view regardless of a limitation on the angle of view, if any. Particularly, mainly described in this embodiment is a case where the information processing apparatus 10 is a see-through HMD. However, the information processing apparatus 10 should not be limited to the HMD. For example, the information processing apparatus 10 may be a smartphone, a mobile phone, a tablet device, a camera, a personal computer (PC), or another device.

The user 20 is able to visually recognize the real space. In an example illustrated in FIG. 1, the information processing apparatus 10 forms a field of view 50-1, and the user 20 is able to visually recognize the real space through the field of view 50-1. Any object may be present in the real space. In the example illustrated in FIG. 1, a real object 31-1 (eatery) is present as an example object that is different from the agent described above in the real space. However, the real object 31-1 (eatery) is a mere example of the object. Another object may thus be present in the real space in place of the real object 31-1 (eatery).

The example configuration of the information processing system according to the embodiment of the present disclosure has been described above.

### 1.2. Example Functional Configuration of Information Processing Apparatus

Next, an example functional configuration of the information processing apparatus 10 is described. FIG. 2 is a diagram illustrating an example functional configuration of the information processing apparatus 10. As illustrated in FIG. 2, the information processing apparatus 10 includes a sensor unit 110, a control unit 120, a storage unit 130, a communication unit 140, and a display unit 150. Additionally, the information processing apparatus 10 may be coupled to a server apparatus (not illustrated) via a communication network. The communication network includes the Internet, for example.

The sensor unit 110 includes a sensor that detects user's action information. The user's action information may include a history of user's actions (e.g., walking, taking a train), a trend in user's action estimated from the action history, user's motions, a time when the user is present (e.g., current time), a position of the user (e.g., current position of the user), a line of sight of the user, user's biological information, user's voice, or the like. For example, in a case where the sensor unit 110 includes at least one of an acceleration sensor or a gyroscope sensor, the action history and the movement of the user may be detected on the basis of at least one of the acceleration sensor or the gyroscope sensor.

Additionally, in a case where the sensor unit 110 includes a clock, the time when the user is present may be detected by the clock. In a case where the sensor unit 110 includes a position sensor (e.g., a global positioning system (GPS) sensor), the position of the user (e.g., the current position of the user) may be detected by the position sensor.

Additionally, in a case where the sensor unit 110 includes an image sensor, the line of sight of the user may be detected on the basis of an image captured by the image sensor. In this embodiment, it is mainly assumed that a central position of a pupil and a position relation of a Purkinje image are detected from the image captured by the image sensor and that the line of sight of the user is detected on the basis of the position relation. However, the line of sight of the user may be detected by any method. For example, an attitude of the user's head may be detected as the line of sight of the user.

Additionally, in a case where the sensor unit 110 includes a biological sensor, the biological information may be detected by the biological sensor. For example, in a case where the biological sensor includes a brain wave sensor, the biological information may contain a brain wave detected by the brain wave sensor. For example, in a case where the sensor unit 110 includes a microphone, a voice of the user may be detected by the microphone.

Additionally, the sensor unit 110 has a function of detecting the position and attitude of the user's head (the sensor unit 110). For example, the sensor unit 110 may include a position sensor (e.g., a global positioning system (GPS) sensor), and the position of the user's head may be detected by the position sensor, as in the case where the position of the user is detected.

Additionally, the sensor unit 110 may include a geomagnetic sensor, and the attitude of the user's head may be detected by the geomagnetic sensor. Further, the sensor unit 110 may detect the attitude of the user's head more accurately on the basis of at least one of the acceleration sensor or the gyroscope sensor, in addition to the geomagnetic sensor or in place of the geomagnetic sensor. Alternatively, in a case where a camera is disposed outside the information processing apparatus 10, an orientation of the face or body recognized from an image captured by the camera may be detected as the attitude of the user's head.

The communication unit 140 includes a communication circuit and has a function of acquiring data from the server apparatus (not illustrated) coupled to the communication network and providing data to the server apparatus (not illustrated) via the communication network. For example, the communication unit 140 includes a communication interface. It is to be noted that one or more communication networks may be coupled to the server apparatus (not illustrated).

The storage unit 130 includes a memory. The storage unit 130 is a recording medium that stores programs to be executed by the control unit 120 and data necessary for execution of these programs. Additionally, the storage unit 130 temporarily stores data for calculation by the control unit 120. The storage unit 130 includes a magnetic storage device, a semiconductor storage device, an optical storage device, a magneto-optical storage device, or the like.

The display unit 150 has a function of displaying various images. The type of the display unit 150 should not be limited. For example, the display unit 150 may be any display that displays an image visually recognizable by the user. The display unit 150 may be a liquid crystal display or an organic electro-luminescence (EL) display.

The control unit 120 executes control of each component of the information processing apparatus 10. The control unit 120 may include, for example, one or more central processing units (CPUs) or the like. In a case where the control unit 120 includes a processing unit such as the CPU, the processing unit may include an electronic circuit. The control unit 120 may be implemented by executing a program by the processing unit.

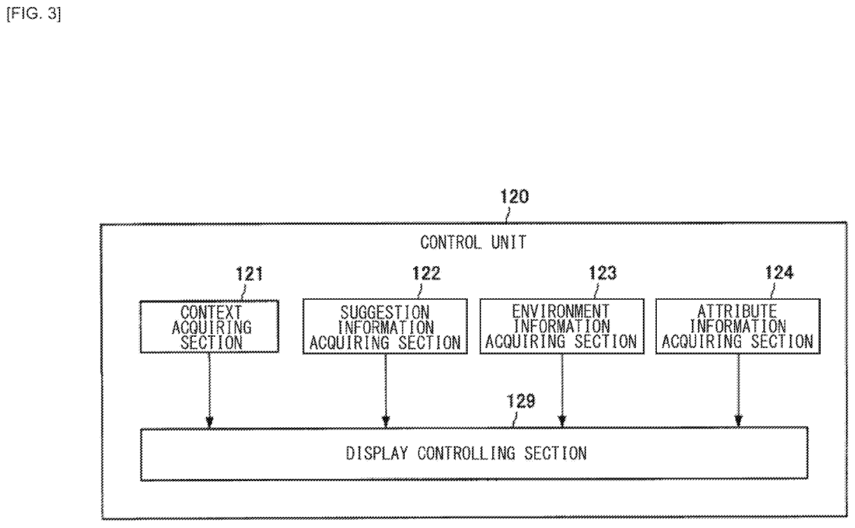

FIG. 3 is a diagram illustrating a detailed example configuration of the control unit 120. As illustrated in FIG. 3, the control unit 120 includes a context acquiring section 121, a suggestion information acquiring section 122, an environment information acquiring section 123, an attribute information acquiring section 124, and a display controlling section 129. Details of these functional blocks are described below.

The example functional configuration of the information processing apparatus 10 according to the embodiment has been described above.

### 1.3. Detailed Description of Function of Information Processing System

Subsequently, detailed functions of the information processing system according to the present embodiment are described.

### 1.3.1. Information to be Used for Agent Control

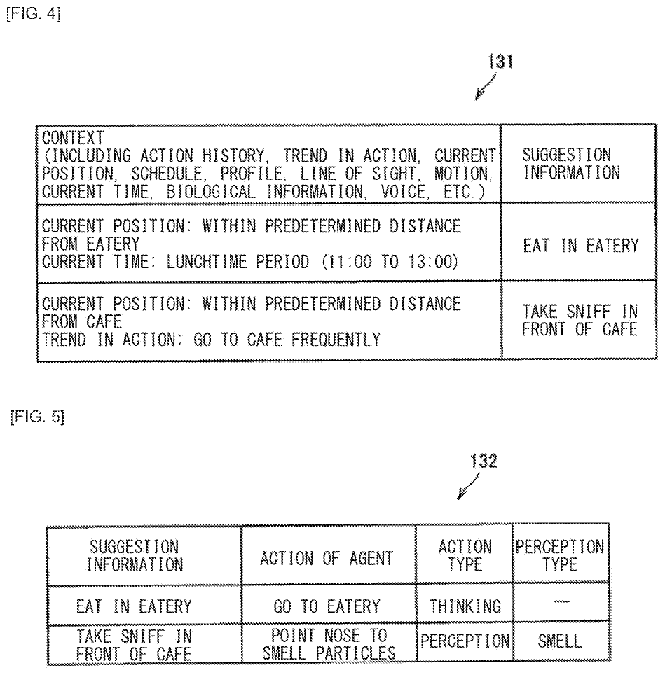

With reference to FIGS. 4 to 8, examples of various types of information to be used for agent control will be described. Referring to FIGS. 4 to 8, there are shown, as the various types of information to be used for the agent control, suggestion definition information 131, agent definition information 132, agent model information 133 corresponding to an action involving thinking, agent model information 134 corresponding to a perceptual action, and map information 135. The various types of information to be used for the agent control are stored in the storage unit 130, and may be appropriately acquired from the storage unit 130 and used.

FIG. 4 is a diagram illustrating an example configuration of the suggestion definition information 131. As illustrated in FIG. 4, the suggestion definition information 131 includes a context and suggestion information in association with each other. For example, the context may include the above-described action information (e.g., a history of user's actions (which may include a current action), a trend in user's action, user's motions, a time when the user is present (e.g., current time), a position of the user (e.g., the current position of the user), a line of sight of the user, user's biological information, user's voice, etc.). The action information may further include information related to user's schedule (e.g., information indicating a user's schedule such as what to do and when to do) and a user's profile (e.g., sex, age, hobby of the user, etc.).

FIG. 5 is a diagram illustrating an example configuration of the agent definition information 132. As illustrated in FIG. 5, the agent definition information 132 includes suggestion information, an action of the agent, an action type, and a perception type in association with each other. The action of agent indicates the action to be taken by the agent. Further, the action type indicates the type of action to be performed by the agent. As illustrated in FIG. 5, the action type may include an action involving “thinking” and an action with “perception” (hereinafter, simply referred to as “perceptual action”).

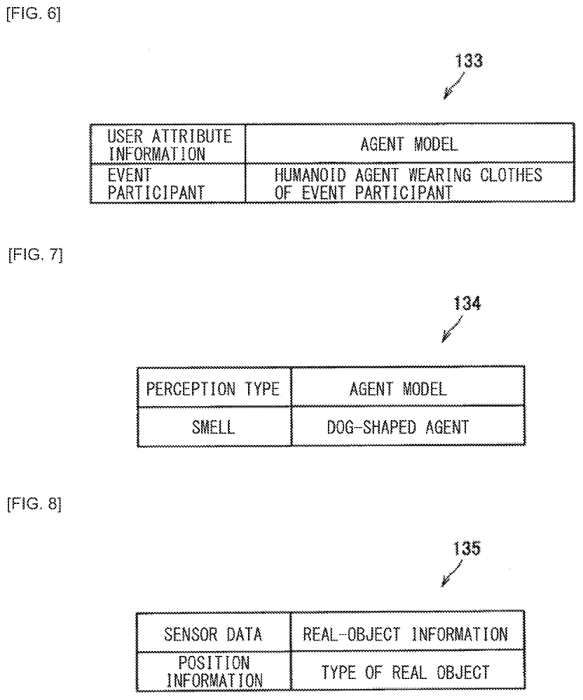

FIG. 6 is a diagram illustrating an example of the agent model information 133 corresponding to the action involving thinking. As illustrated in FIG. 6, the agent model information 133 corresponding to the action involving thinking includes user attribute information and an agent model in association with each other. In the example indicated in FIG. 6, user attribute information “event participant” is associated with a “humanoid agent wearing clothes of an event participant”. However, the user attribute information should not be limited to the event participant. For example, the user attribute information may include information about a sex of the user and information about an age of the user.

FIG. 7 is a diagram illustrating an example configuration of the agent model information 134 corresponding to the perceptual action. As illustrated in FIG. 7, the agent model information 134 corresponding to the perceptual action includes a perception type with an agent model in association with each other. The perception type indicates a type of perceptual action. In FIG. 7, “smell” is indicated as an example of the perception type, but the perception type should not be limited to “smell”. For example, the perception type may include vision, may include hearing, may include touch, or may include taste. The agent model should also not be limited to a “dog-shaped agent”.

FIG. 8 is a diagram illustrating an example configuration of the map information 135. As illustrated in FIG. 8, the map information 135 includes sensor data and real-object information in association with each other. Examples of the sensor data include position information (e.g., latitude, longitude, etc.) of the user. Additionally, examples of the real-object information include information related to type of the real object. In this embodiment, the type of the real object should not be limited. For example, the type of the real object may be the type of a store (e.g., convenience store, cafe, eatery, etc.) or the type of a facility (e.g., station, etc.).

The examples of the various types of information used for controlling the agent have been described above.

### 1.3.2. Control of Agent

Subsequently, examples of control of the agent are described. Here, in the information processing apparatus 10, the context acquiring section 121 acquires the context of the user. The context acquiring section 121 may also function as an action information acquiring section that acquires action information as an example of the context. The suggestion information acquiring section 122 acquires, on the basis of the context acquired by the context acquiring section 121, suggestion information for the user related to a surrounding environment of the user based on a timing of acquiring the context. The display controlling section 129 controls, on the basis of the suggestion information, the display unit 150 (display device) to display an agent that performs an action based on the suggestion information in a field of view of the user.

According to such a configuration, since the suggestion information is provided indirectly to the user via an object, it possible to make a suggestion to the user while reducing discomfort given to the user as compared to a case where the suggestion information is provided as the text data to the user. Additionally, according to such a configuration, even if no explicit input is made by user, the suggestion information is acquired on the basis of the automatically acquired context, thereby reducing a burden on the input to be made by the user.

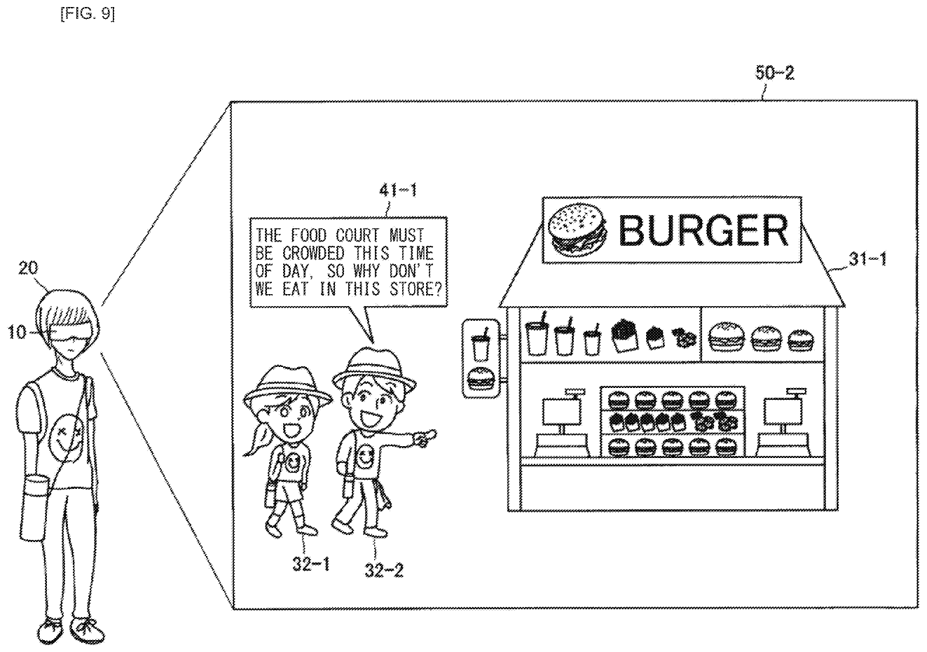

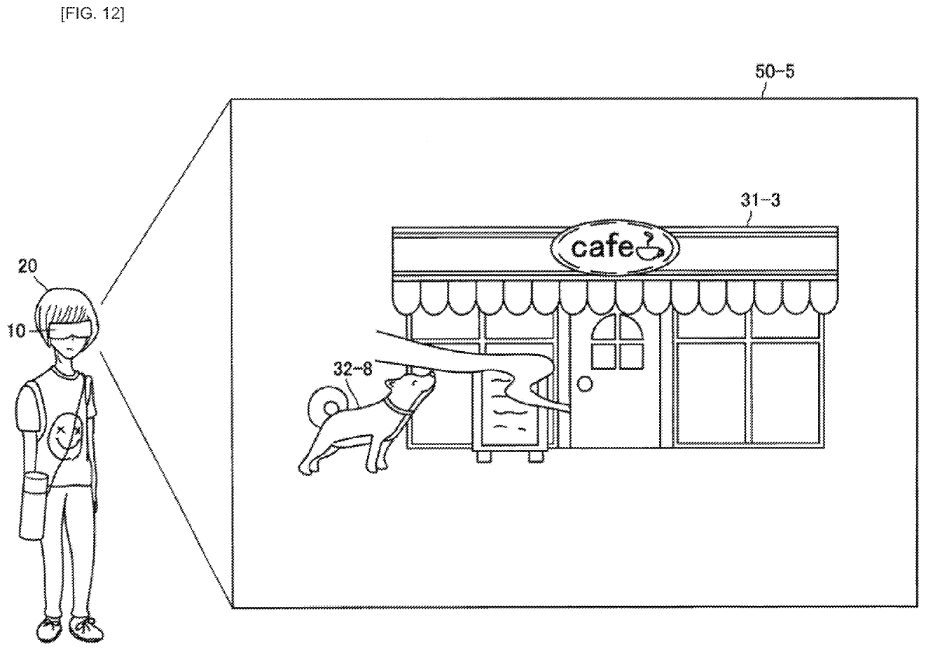

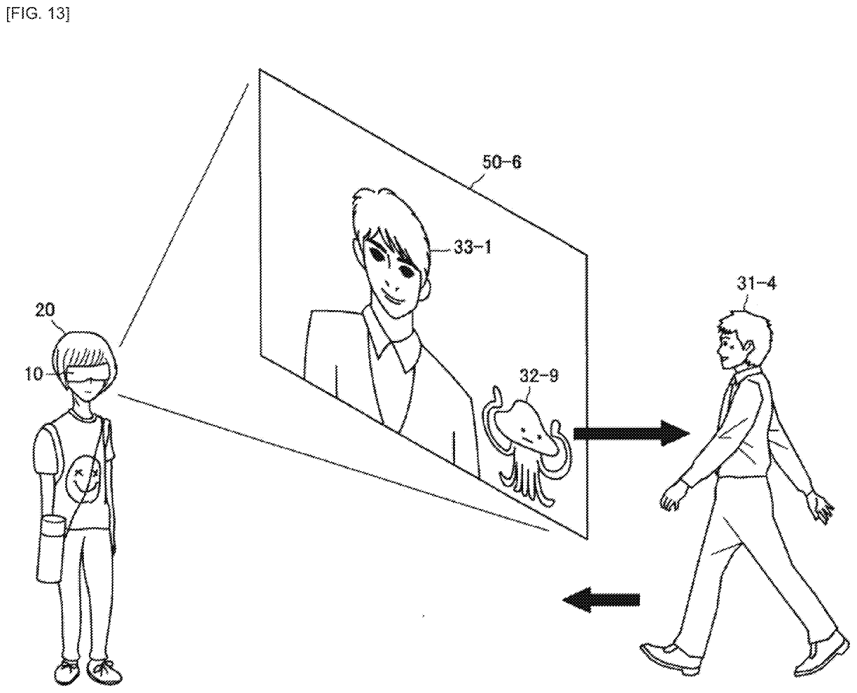

Hereinafter, the example control of the agent is described with reference to FIGS. 9 to 15 (with reference to FIGS. 1 to 8 as appropriate). Specifically, first, with reference to FIGS. 9 to 11 (also with reference to FIGS. 1 to 8 as appropriate), examples of causing the agent to perform an action involving thinking are described. Subsequently, with reference to FIGS. 12 to 15 (also with reference to FIGS. 1 to 8 as appropriate), examples of causing the agent to perform a perceptual action are described.

FIG. 9 is a diagram illustrating a first example of causing the agent to perform an action involving thinking. With reference to FIG. 9, a field of view 50-2 of the user 20 is illustrated. The real object 31-1 (eatery) is present in the real space, and the real object 31-1 (eatery) is present in the field of view 50-2. Additionally, it is assumed a case where information in which the type of the real object (eatery) is associated with position information of the real object is registered as the map information 135 (FIG. 8).

In addition, it is assumed a case where information in which a context “the current position of the user is within a predetermined distance from the position of the eatery, and the current time belongs to a lunchtime period (11:00 to 13:00)” is associated with suggestion information “eat in eatery” is registered as the suggestion definition information 131 (FIG. 4). Further, it is assumed a case where information in which the suggestion information “eat in eatery”, an action of the agent “go to eatery”, and an action type “action involving thinking” are associated with each other is registered as the agent definition information 132 (FIG. 5).

In this case, the environment information acquiring section 123 acquires environment information. More specifically, when the sensor unit 110 detects the position and attitude of the user, the environment information acquiring section 123 may acquire, as the environment information, a relative position relation between the user and the real object 31-1 (eatery) on the basis of the position and attitude of the user and the map information 135 (FIG. 8) (for example, the position of the real object 31-1 (eatery) in the field of view of the user).

The relative position relation between the user and the real object 31-1 (eatery) may be acquired by any method. For example, the relative position relation between the user and the real object 31-1 (eatery) may be recognized directly from a captured image of the field of view of the user. Further, the environment information should not be limited to the relative position relation between the user and the real object 31-1 (eatery). For example, the environment information may be an environmental sound detected in the environment surrounding the user by a microphone, or may be illuminance detected by an illuminance sensor.

The context acquiring section 121 acquires that the position (current position) of the user is within a predetermined distance from the position of the eatery on the basis of the environment information. In addition, the context acquiring section 121 acquires that the current time belongs to the lunchtime period (11:00 to 13:00). The suggestion information acquiring section 122 acquires the suggestion information for the user related to the surrounding environment of the user. More specifically, on the basis of the suggestion definition information 131 (FIG. 4), the suggestion information acquiring section 122 acquires the suggestion information “eat in eatery” corresponding to the context “the position (current position) of the user is within a predetermined distance from the position of the eatery and the current time belongs to the lunchtime period (11:00 to 13:00)”.

In addition, the display controlling section 129 acquires, on the basis of the agent definition information 132 (FIG. 5), the action of the agent “go to eatery” and the action type “action involving thinking” which correspond to the suggestion information “eat in eatery”. The display controlling section 129 controls the display unit 150 to display, in the field of view 50-2, agents (an agent 32-1 and an agent 32-2) that perform the action of the agent “go to eatery” that has been acquired by the suggestion information acquiring section 122. It is to be noted that the number of agents displayed in the field of view 50-2 should not be limited to two, and may be one or three or more.

More specifically, the attribute information acquiring section 124 acquires user attribute information in a case where the action type “action involving thinking” is acquired by the suggestion information acquiring section 122. The display controlling section 129 acquires an agent corresponding to the user attribute information acquired by the attribute information acquiring section 124. Thereafter, the display controlling section 129 controls the display unit 150 to display the acquired agent.

For example, the user attribute information may be a context on which the suggestion is based. For example, if the suggestion information is acquired on the basis of a context that event participation is scheduled, an agent having an appearance (e.g., clothes, items, etc.) that the attribute information “event participant” often has may be displayed. As a result, it can be easily understood that the suggestion is made to the event participant only by looking at the appearance of the agent. The attribute information “event participant” may be replaced with the attribute information of sex, age, or the like. Further, in a case where the suggestion information is acquired on the basis of the action history, an agent accompanied by the user may be displayed during the action of the user.

Here, it is assumed that the attribute information acquiring section 124 acquires the user attribute information “event participant”, and the display controlling section 129 acquires, on the basis of the agent model information 133 corresponding to the action involving thinking, an agent model “clothes model of event participant” corresponding to the user attribute information “event participant”. At this time, the display controlling section 129 controls the display unit 150 to display, in the field of view 50-2, the agent models “clothes models of event participants” (the agent 32-1 and the agent 32-2) which perform the action of the agent “go to eatery”.

Referring to FIG. 9, a state in which the agent 32-1 and the agent 32-2 each wearing the clothes of the event participant go toward the real object 31-1 (eatery) is displayed in the field of view 50-2. Further, referring to FIG. 9, a comment 41-1 related to the suggestion information “eat in eatery” is displayed in association with the agent 32-2 by the display controlling section 129. However, the comment 41-1 may be outputted in any manner and may be outputted as a voice.

It is to be noted that the example is assumed in which the user attribute information includes the event participant. However, the user attribute information is not limited to the example including the event participant. For example, the user attribute information may include clothes of the user or sex information of the user. In such cases, the display controlling section 129 acquires an agent corresponding to the user attribute information acquired by the attribute information acquiring section 124 (e.g., an agent corresponding to attribute information that is substantially identical to the user attribute information). Thereafter, the display controlling section 129 controls the display unit 150 to display the acquired agent. This makes it possible to make a suggestion to the user more effectively by taking advantage of the psychological characteristics of the user that the user is more likely to follow the actions of someone similar to himself/herself.

For example, the attribute information acquiring section 124 may acquire user attribute information “clothes of user”, and the display controlling section 129 may control the display unit 150 to display an agent model “model wearing clothes that is substantially identical to clothes of user” that corresponds to the user attribute information “clothes of user”. Alternatively, the attribute information acquiring section 124 may acquire user attribute information “user's sex information”, and the display controlling section 129 may control the display unit 150 to display an agent model “model of sex that is identical to sex of user” that corresponds to the user attribute information “user's sex information”.

The user attribute information may be acquired in any way. For example, clothes recognized from an image captured by the sensor unit 110 may be acquired as the user attribute information. Alternatively, clothes corresponding to schedule information registered within a predetermined time period from a current time may be acquired as the user attribute information. For example, if schedule information of event participation is registered as schedule information of today, clothes that is often worn participating in the event may be acquired as the user attribute information. In addition, the sex information or the age information of the user based on a pre-registered profile may be acquired as the user attribute information.

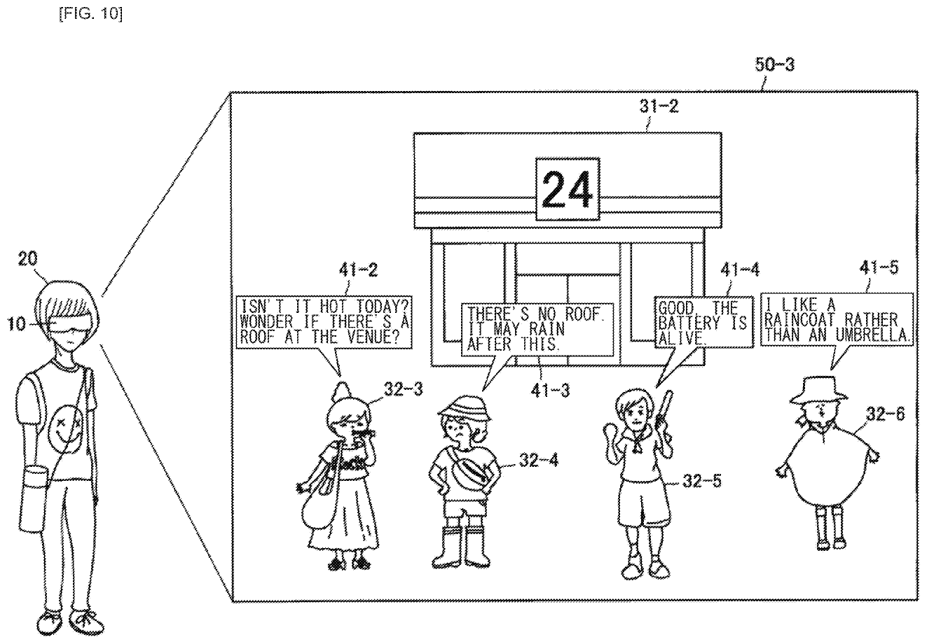

FIG. 10 is a diagram illustrating a second example of causing the agent to perform an action involving thinking. Referring to FIG. 10, a field of view 50-3 of the user 20 is illustrated. A real object 31-2 (convenience store) is present in the real space, and the real object 31-2 (convenience store) is present in the field of view 50-3. In addition, it is assumed a case where information in which a type of the real object (convenience store) is associated with position information of the real object is registered as the map information 135 (FIG. 8).

Further, it is assumed a case where information in which a context “the current position of the user is within a predetermined distance from the position of the convenience store, and today's weather forecast is rain” is associated with suggestion information “purchase rain apparel” is registered as the suggestion definition information 131. Further, it is assumed a case where information in which the suggestion information “purchase rain apparel”, an action of the agent “exist in front of the convenience store”, and an action type “action involving thinking” are associated with each other is registered as the agent definition information 132.

Additionally, it is assumed a case where information in which a context “the current position of the user is within a predetermined distance from the position of the convenience store, and the schedule information of event participation is registered as today's schedule information” is associated with suggestion information “purchase battery for penlight” is registered as the suggestion definition information 131. Further, it is assumed a case where information in which the suggestion information “purchase battery for penlight”, the action of the agent “exist in front of the convenience store”, and the action type “action involving thinking” are associated with each other is registered as the agent definition information 132.

The environment information acquiring section 123 acquires environment information in a similar manner as described above. More specifically, the environment information acquiring section 123 acquires, as the environment information, a relative position relation between the user and the real object 31-2 (convenience store) (for example, the position of real object 31-2 (convenience store) in the field of view of the user).

The context acquiring section 121 acquires that the position (current position) of the user is within a predetermined distance from the position of the real object 31-2 (convenience store) on the basis of the environment information. In addition, the context acquiring section 121 acquires that the today's weather forecast is rain on the basis of the weather forecast (e.g., retrieved from a given web page). The suggestion information acquiring section 122 acquires the suggestion information for the user related to the surrounding environment of the user. Here, the surrounding environment of the user includes weather of an area around the user. More specifically, on the basis of the suggestion definition information 131, the suggestion information acquiring section 122 acquires the suggestion information acquires the suggestion information “purchase rain apparel” corresponding to the context “the position (current position) of the user is within a predetermined distance from the position of the convenience store, and today's weather forecast is rain”.

In addition, the display controlling section 129 acquires, on the basis of the agent definition information 132, the action of the agent “exist in front of the convenience store” and the action type “action involving thinking” which correspond to the suggestion information “purchase rain apparel”. The display controlling section 129 controls the display unit 150 to display the agent that performs an action related to the weather. The action related to the weather may include an action related to purchasing the rain apparel (e.g., the action of existing in front of the convenience store).

More specifically, the display controlling section 129 controls the display unit 150 to display, in the field of view 50-3, agents (an agent 32-3, an agent 32-4, and an agent 32-6) that perform the action of the agent “exist in front of the convenience store” acquired by the suggestion information acquiring section 122. It is to be noted that the action related to purchasing the rain apparel may be an action of entering the convenience store or an action of coming out from the convenience store, instead of the action of existing in front of the convenience store. Further, since the convenience store is only an example of the store selling rain apparel, the convenience store may be replaced by another store selling rain apparel.

In addition, the context acquiring section 121 acquires from the storage unit 130 that the schedule information of event participation is registered as today's schedule information. The suggestion information acquiring section 122 acquires the suggestion information for the user related to the surrounding environment of the user. More specifically, on the basis of the suggestion definition information 131, the suggestion information acquiring section 122 acquires the suggestion information “purchase battery for penlight” corresponding to the context “the current position of the user is within a predetermined distance from the position of the convenience store, and the schedule information of event participation is registered as today's schedule information”.

In addition, the display controlling section 129 acquires, on the basis of the agent definition information 132, the action of the agent “exist in front of the convenience store” and the action type “action involving thinking” which correspond to the suggestion information “purchase battery for penlight”. The display controlling section 129 controls the display unit 150 to display an agent that performs the purchase action related to the surrounding environment. More specifically, the display controlling section 129 controls the display unit 150 to place the agent in front of a store in which it is possible to perform the purchase action.

More specifically, the display controlling section 129 controls the display unit 150 to display, in the field of view 50-3, an agent (agent 32-5) that performs the action of the agent “exist in front of the convenience store” acquired by the suggestion information acquiring section 122. It is to be noted that the purchase action may be an action of entering the convenience store or an action of coming out from the convenience store, instead of the action of existing in front of the convenience store. Further, since the convenience store is only an example of the store in which the purchase action can be performed, the convenience store may be replaced by another store in which the purchase action can be performed.

Referring to FIG. 10, the display controlling section 129 displays a comment 41-2 related to the suggestion information “purchase rain apparel” is displayed in association with the agent 32-3, a comment 41-3 related to the suggestion information “purchase rain apparel” is displayed in association with the agent 32-4, and a comment 41-5 related to the suggestion information “purchase rain apparel” is displayed in association with the agent 32-6. Also, a comment 41-4 related to the suggestion information “purchase battery for penlight” is displayed in association with the agent 32-5. However, the comments 41-2 to 41-5 may be outputted in any manner and may each be outputted as a voice.

For example, in a case where those comments are each outputted as a voice, and when it is detected that the line of sight of the user 20 is directed to an area corresponding to an agent, a comment corresponding to the agent may be outputted. Alternatively, even in a state in which a plurality of voices are outputted at the same time, all comments may be outputted at the same time as the voices by utilizing a phenomenon (so-called “cocktail party effect”) that a person is naturally able to hear a voice of his/her own interest.

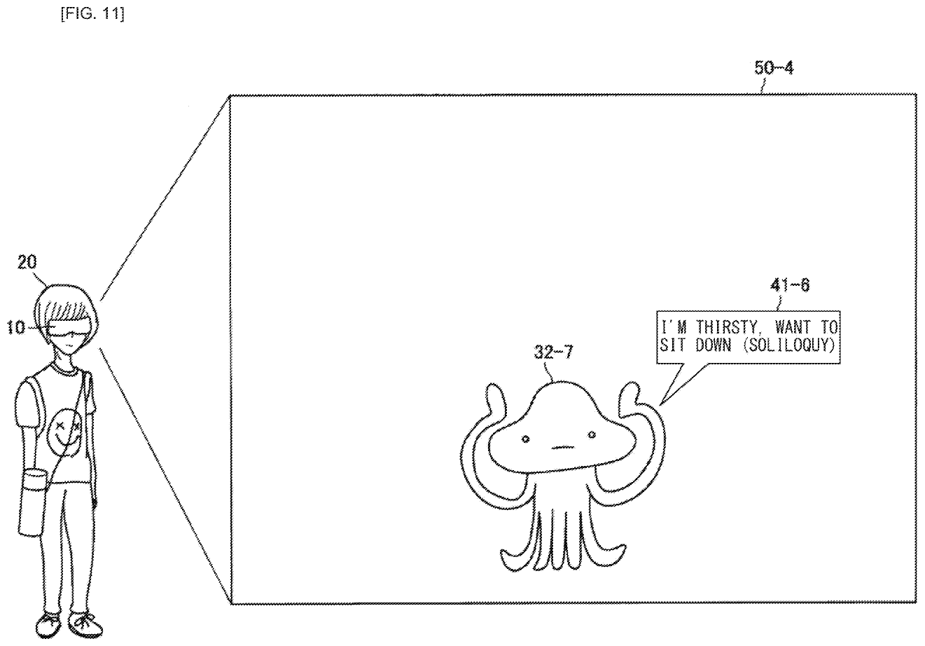

FIG. 11 is a diagram illustrating a third example of causing the agent to perform an action involving thinking. Referring to FIG. 11, a field of view 50-4 of the user 20 is illustrated. It is assumed a case where information in which a context “tiredness state” is associated with suggestion information “recovery” is registered as the suggestion definition information 131. Further, it is assumed a case where information in which the suggestion information “recovery”, an action of the agent “recovery action”, and an action type “action involving thinking” are associated with each other is registered as the agent definition information 132.

The context acquiring section 121 acquires, as an example of the user's action information, state information indicating a tiredness state of the user 20. Here, assumed as the tiredness state is a case where a walking distance of the user 20 is greater than or equal to a predetermined distance. The walking distance may be measured on the basis of an acceleration detected by an acceleration sensor and an angular velocity detected by a gyro sensor. However, the tiredness state should not be limited to such an example.

The suggestion information acquiring section 122 acquires the suggestion information “recovery” corresponding to the context “tiredness state”. In addition, the display controlling section 129 acquires, on the basis of the agent definition information 132, the action of the agent “recovery action” and the action type “action involving thinking” which correspond to the suggestion information “recovery”. The display controlling section 129 controls the display unit 150 to display the agent that performs the recovery action based on the tiredness state of the user.

More specifically, the display controlling section 129 controls the display unit 150 to display, in the field of view 50-4, an agent (agent 32-7) that performs the action of the agent “recovery action” acquired by the suggestion information acquiring section 122. It is to be noted that the suggestion information “recovery” may include at least one of a break and hydration, and the agent action “recovery action” may include at least one of a break-related action or a hydration-related action.

Referring to FIG. 11, as an example of the recovery action, the agent 32-7 of a fatigue facial expression is displayed. However, the recovery action is not limited to such an example. For example, the recovery action may be an action of having a break, an action to be hydrated, or an action of buying a drink. Further, referring to FIG. 11, the display controlling section 129 displays a comment 41-6 related to the suggestion information “recovery” in association with the agent 32-7. However, the comment 41-6 may be outputted in any manner and may be outputted as a voice.

FIG. 12 is a diagram illustrating a first example of causing the agent to perform a perceptual action. With reference to FIG. 12, a field of view 50-5 of the user 20 is illustrated. A real object 31-3 (cafe) is present in the real space, and the real object 31-3 (cafe) is present in the field of view 50-5. Additionally, it is assumed a case where information in which the type of the real object (cafe) is associated with position information of the real object is registered as the map information 135 (FIG. 8).

In addition, it is assumed a case where information in which a context “the current position of the user is within a predetermined distance from the position of the cafe, and there is a trend in action of going to the cafe frequently” is associated with suggestion information “take a sniff in front of the cafe” is registered as the suggestion definition information 131 (FIG. 4). Further, it is assumed a case where information in which the suggestion information “take a sniff in front of the cafe”, an action of the agent “point the nose to smell particles”, an action type “perceptual action”, and a perception type “smell” are associated with each other is registered as the agent definition information 132 (FIG. 5).

The environment information acquiring section 123 acquires environment information in a similar manner as described above. More specifically, the environment information acquiring section 123 acquires, as the environment information, a relative position relation between the user and the real object 31-3 (cafe) (for example, the position of the real object 31-3 (cafe) in the field of view of the user).

The context acquiring section 121 acquires that the position (current position) of the user is within a predetermined distance from the position of the cafe on the basis of the environment information. In addition, the context acquiring section 121 acquires that there is a trend in action of going to the cafe frequently. The suggestion information acquiring section 122 acquires the suggestion information for the user related to the surrounding environment of the user. More specifically, on the basis of the suggestion definition information 131 (FIG. 4), the suggestion information acquiring section 122 acquires the suggestion information “take a sniff in front of the cafe” corresponding to the context “the position (current position) of the user is within a predetermined distance from the position of the cafe, and there is a trend in action of going to the cafe frequently”.

In addition, the display controlling section 129 acquires, on the basis of the agent definition information 132 (FIG. 5), the action of the agent “point the nose to smell particles”, the action type “perceptual action”, and the perception type “smell”, which correspond to the suggestion information “take a sniff in front of the cafe”. In a case where the suggestion information acquiring section 122 acquires the action type “perceptual action”, the display controlling section 129 controls the display unit 150 to display an agent that performs a perceptual action with respect to a surrounding environment related to at least one of vision, taste, smell, hearing, or touch. In particular, in a case where the suggestion information acquiring section 122 acquires the action type “perceptual action” and the perception type “smell”, the display controlling section 129 controls the display unit 150 to cause the nose to be pointed to smell particles (so as to change the direction of the nose of the agent to a direction of the smell particles included in the surrounding environment).

More specifically, the display controlling section 129 acquires, on the basis of the agent model information 134 corresponding to the perceptual action, an agent model “dog-shaped agent” corresponding to the perception type “smell”. The display controlling section 129 then controls the display unit 150 to display, in the field of view 50-5, the agent model “dog-shaped agent” (an agent 32-8) that performs the action of the agent “point the nose to smell particles”.

The display of the agent model “dog-shaped agent” corresponding to the perception type “smell” makes it easier for the user to understand the perception type “smell”. Alternatively, an agent model “humanoid agent” may be displayed instead of the agent model “dog-shaped agent”; however, an effect may be applied to the humanoid agent such that a sensory organ “nose” corresponding to the perception type “smell” is highlighted. In addition, pointing the nose of the agent model to smell particles makes it easier for the user to understand in which direction the smelling should be performed. The direction in which the smell particles are present may be a direction toward the position of the real object 31-3 (cafe).

FIG. 13 is a diagram illustrating a second example of causing the agent to perform a perceptual action. With reference to FIG. 13, a field of view 50-6 of the user 20 is illustrated. A real object 31-4 is present in the real space, and a virtual object 33-1 obtained by imaging a communication partner with the user 20 is present in the field of view 50-6. It is to be noted that, as illustrated in FIG. 13, it is mainly assumed that the real object 31-4 is a moving object (e.g., a person, a bicycle, a car, etc.); however, the type of the real object 31-4 should not be limited. Further, the virtual object 33-1 should not be limited to a virtual object obtained by imaging a communication partner.

In addition, it is assumed a case where information in which a context “the real object is approaching the user, and the display unit is displaying the virtual object” is associated with suggestion information “direct the line of light to the real object” is registered as the suggestion definition information 131. Further, it is assumed a case where information in which the suggestion information “direct the line of light to the real object”, an action of the agent “change the direction of the line of sight to a direction of the real object”, an action type “perceptual action”, a perception type “vision” are associated with each other is registered as the agent definition information 132.

At this time, the environment information acquiring section 123 acquires environment information. More specifically, the environment information acquiring section 123 acquires a position of the real object 31-4 (a relative position relation between the information processing apparatus 10 and the real object 31-4) on the basis of the image captured by the image sensor included in the sensor unit 110. Further, the environment information acquiring section 123 acquires, as the environment information, a change in the position of the real object 31-4 (e.g., whether the real object 31-4 is approaching the user).

The context acquiring section 121 acquires that the real object 31-4 is approaching user on the basis of the environment information. In addition, the context acquiring section 121 acquires that the display unit 150 is displaying the virtual object 33-1. The suggestion information acquiring section 122 acquires a suggestion information for the user related to the surrounding environment of the user. More specifically, on the basis of the suggestion definition information 131, the suggestion information acquiring section 122 acquires the suggestion information “direct the line of light to the real object” corresponding to the context “the real object is approaching the user, and the display unit is displaying the virtual object”.

In addition, the display controlling section 129 acquires, on the basis of the agent definition information 132, the action of the agent “change the direction of the line of sight to a direction of the real object”, the action type “perceptual action”, and the perception type “vision”, which correspond to the suggestion information “direct the line of light to the real object”. In a case where the suggestion information acquiring section 122 acquires the action type “perceptual action” and the perception type “vision”, the display controlling section 129 controls the display unit 150 to change the direction of the line of sight to the direction of the real object (so as to change the direction of the line of sight of the agent to a direction of the real object included in the surrounding environment).

More specifically, the display controlling section 129 acquires, on the basis of the agent model information 134 corresponding to the perceptual action, an agent model “humanoid agent” corresponding to the perception type “vision”. The display controlling section 129 then controls the display unit 150 to display, in the field of view 50-6, the agent model “humanoid agent” (an agent 32-9) that performs the action of the agent “direct the line of sight to the real object (real object 31-4)”.

Since the direction of the line of sight of a person is easier to grasp than the direction of the line of sight of other animals, the display of the “humanoid agent” as the agent model corresponding to the perception type “vision” makes it easier for the user to notice the change in the line of sight of the agent. In addition, directing the line of sight of the agent model to the real object makes it easier for the user to grasp in which direction the line of sight should be directed.

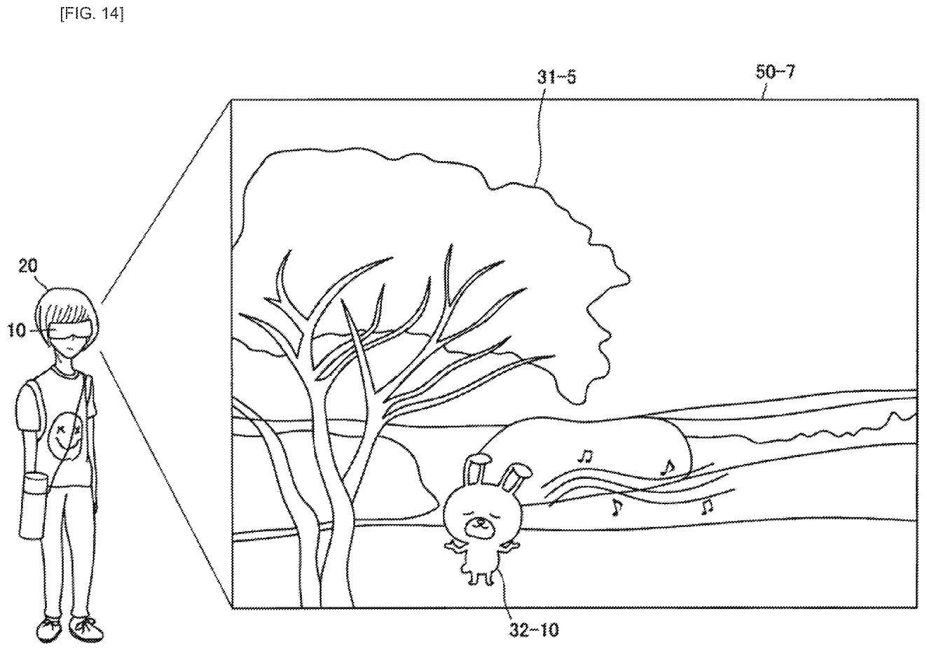

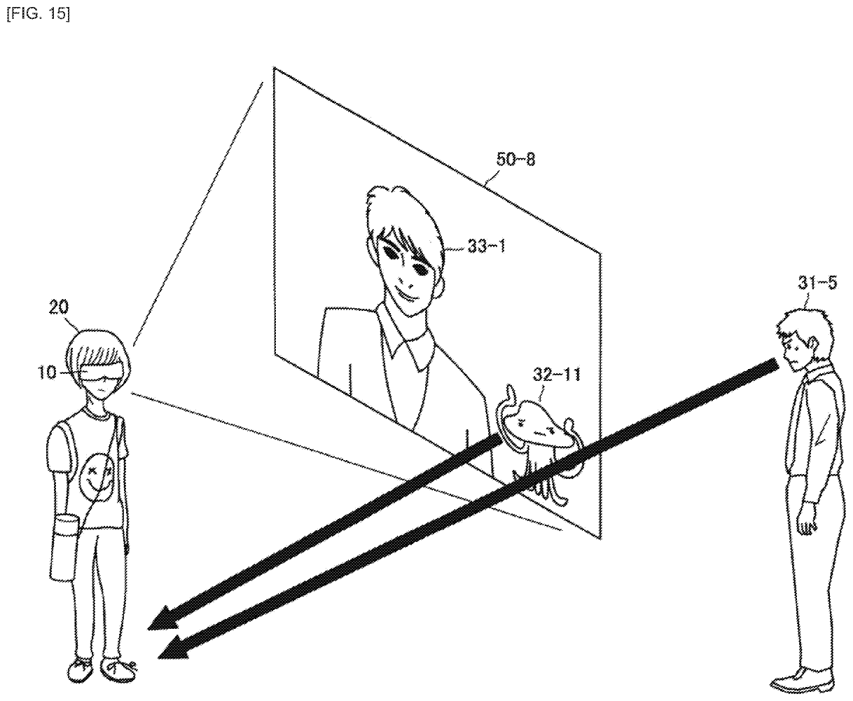

FIG. 14 is a diagram illustrating a third example of causing the agent to perform a perceptual action. With reference to FIG. 14, a field of view 50-7 of the user 20 is illustrated. A real object 31-5 (scenic spot) is present in the real space, and the real object 31-5 (scenic spot) is present in the field of view 50-5. Additionally, it is assumed a case where information in which the type of the real object (scenic spot) is associated with position information of the real object is registered as the map information 135 (FIG. 8).

In addition, it is assumed a case where information in which a context “the current position of the user is within a predetermined distance from the position of the scenic spot” is associated with suggestion information “listen carefully” is registered as the suggestion definition information 131. Further, it is assumed a case where information in which the suggestion information “listen carefully”, an action of the agent “bend ears to sound”, an action type “perceptual action”, and a perception type “hearing” are associated with each other is registered as the agent definition information 132.

The environment information acquiring section 123 acquires environment information in a similar manner as described above. More specifically, the environment information acquiring section 123 acquires, as the environment information, a relative position relation between the user and the real object 31-3 (scenic spot) (for example, the position of the real object 31-3 (scenic spot) in the field of view of the user).

The context acquiring section 121 acquires that the position (current position) of the user is within a predetermined distance from the position of the scenic spot on the basis of the environment information. The suggestion information acquiring section 122 acquires the suggestion information for the user related to the surrounding environment of the user. More specifically, on the basis of the suggestion definition information 131, the suggestion information acquiring section 122 acquires the suggestion information “listen carefully” corresponding to the context “the position (current position) of the user is within a predetermined distance from the position of the scenic spot”.

In addition, the display controlling section 129 acquires, on the basis of the agent definition information 132 (FIG. 5), the action of the agent “bend ears to sound”, the action type “perceptual action”, and the perception type “hearing”, which correspond to the suggestion information “listen carefully”. In a case where the suggestion information acquiring section 122 acquires the action type “perceptual action” and the perception type “hearing”, the display controlling section 129 controls the display unit 150 to bend the ears to the sound (so as to bend the ears of the agent to the sound included in the surrounding environment).

More specifically, the display controlling section 129 acquires, on the basis of the agent model information 134 corresponding to the perceptual action, an agent model “rabbit-shaped agent” corresponding to the perception type “vision”. The display controlling section 129 then controls the display unit 150 to display, in the field of view 50-7, the agent model “rabbit agent” (an agent 32-10) that performs the action of the agent “bend ears to sound”.

The display of the agent model “rabbit-shaped agent” corresponding to the perception type “hearing” makes it easier for the user to understand the perception type “hearing”. Alternatively, an agent model “humanoid agent” may be displayed instead of the agent model “rabbit-shaped agent”; however, an effect may be applied to the humanoid agent such that a sensory organ “ear” corresponding to the perception type “hearing” is highlighted. In addition, bending the ears of the agent model to the sound makes it easier for the user to understand in which direction the careful listening should be performed. The direction in which the sound is present may be a direction toward the position of the real object 31-5 (scenic spot).

FIG. 15 is a diagram illustrating a fourth example of causing the agent to perform a perceptual action. With reference to FIG. 15, a field of view 50-8 of the user 20 is illustrated. A real object 31-5 is present in the real space, and a virtual object 33-1 obtained by imaging a communication partner with the user 20 is present in the field of view 50-8. It is to be noted that, as illustrated in FIG. 15, it is mainly assumed that the real object 31-5 is a person; however, the type of the real object 31-5 should not be limited. Further, the virtual object 33-1 should not be limited to a virtual object obtained by imaging a communication partner.

In addition, it is assumed a case where information in which a context “shoelace untied” is associated with suggestion information “look at foot” is registered as the suggestion definition information 131. Further, it is assumed a case where information in which the suggestion information “look at foot”, an action of the agent “reproduce negative reaction”, an action type “perceptual action”, and a perception type “vision” are associated with each other is registered as the agent definition information 132.

At this time, the environment information acquiring section 123 acquires environment information. More specifically, the environment information acquiring section 123 acquires a position of the real object 31-5 (a relative position relation between the information processing apparatus 10 and the real object 31-5) on the basis of the image captured by the image sensor included in the sensor unit 110. Further, the environment information acquiring section 123 acquires, as the environment information, a reaction of the real object 31-5 with respect to the user (e.g., whether the line of sight is directed to the user, etc.).

Here, the context acquiring section 121 acquires, on the basis of the environment information, a negative reaction of the real object 31-5 with respect to the user. As illustrated in FIG. 15, the negative reaction may include that the object 31-5 that is in the surrounding environment directs the line of sight to the user. The context acquiring section 121 determines the user's action information on the basis of the negative reaction. In the example illustrated in FIG. 15, the line of sight of the real object 31-5 is directed to the foot of the user. The context acquiring section 121 then determines that the user's shoelace is untied.

The suggestion information acquiring section 122 acquires a suggestion information for the user related to the surrounding environment of the user. More specifically, on the basis of the suggestion definition information 131, the suggestion information acquiring section 122 acquires the suggestion information “look at foot” corresponding to the context “shoelace untied”.

In addition, the display controlling section 129 acquires, on the basis of the agent definition information 132, the action of the agent “reproduce negative reaction”, the action type “perceptual action”, and the perception type “vision”, which correspond to the suggestion information “look at foot”. In a case where the suggestion information acquiring section 122 acquires the action type “perceptual action” and the perception type “vision”, the display controlling section 129 controls the display unit 150 to display an agent that reproduces the negative reaction.

More specifically, the display controlling section 129 acquires, on the basis of the agent model information 134 corresponding to the perceptual action, an agent model “humanoid agent” corresponding to the perception type “vision”. The display controlling section 129 then controls the display unit 150 to display, in the field of view 50-8, the agent model “humanoid agent” (an agent 32-11) that performs the action of the agent “reproduce negative reaction”. In the example illustrated in FIG. 15, the agent 32-11 reproduces the negative reaction that the line of sight is directed to the user.

The examples of control of the agent have been described above.

### 1.3.3. Operation of Information Processing Apparatus

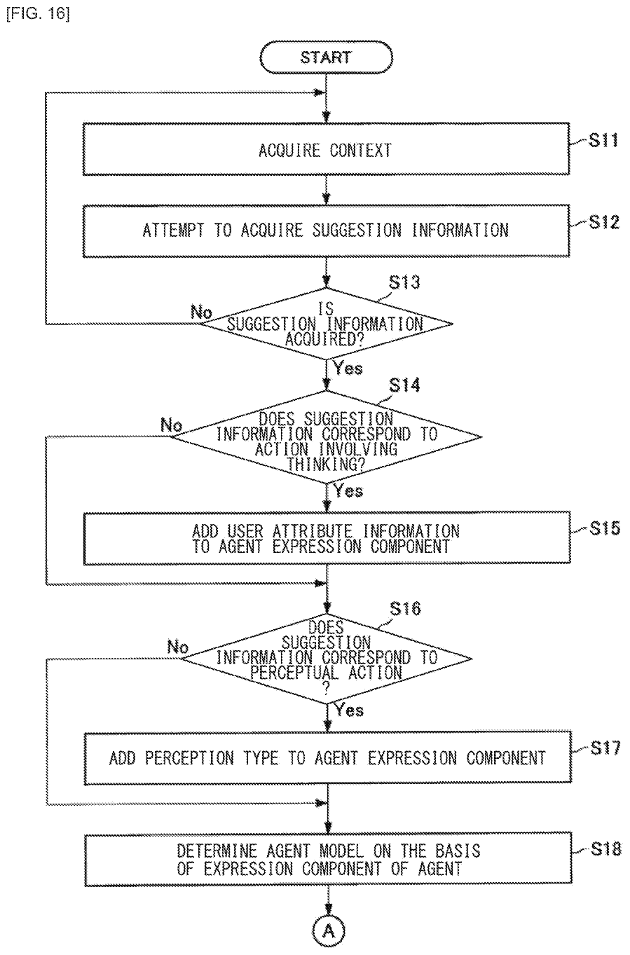

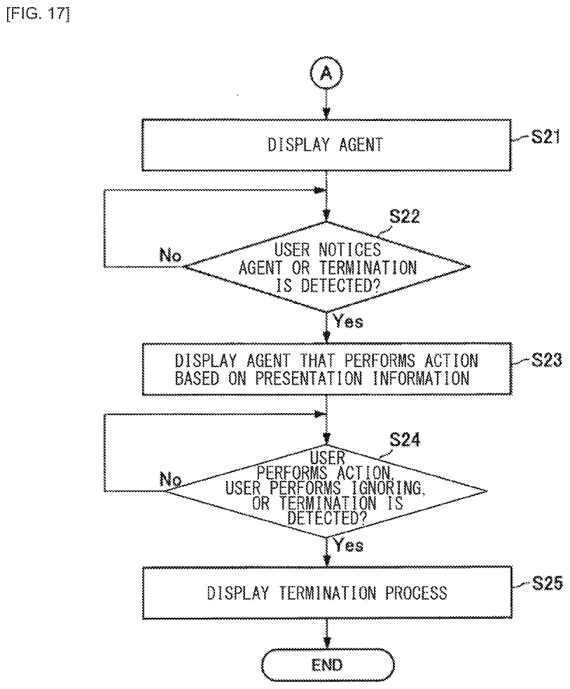

Referring to FIGS. 16 and 17, an example operation of the information processing apparatus 10 is described. FIGS. 16 and 17 are flowcharts illustrating an example operation of the information processing apparatus 10. It is to be noted that the flowcharts illustrated in FIGS. 16 and 17 are only an example of the operation of the information processing apparatus 10. Therefore, the operation of the information processing apparatus 10 should not be limited to the example illustrated in FIGS. 16 and 17.

First, as illustrated in FIG. 16, a context is acquired by the context acquiring section 121 (S11). The context may include the user's action information as described above, as well as user's schedule information and a user's profile. The suggestion information acquiring section 122 attempts to acquire suggestion information on the basis of the context acquired by the context acquiring section 121 (S12). In a case where the suggestion information is not acquired (“No” in S13), the operation shifts to S11. In contrast, in a case where the suggestion information is acquired (“Yes” in S13), the operation shifts to S14.

In a case where the suggestion information does not correspond to the action involving thinking (“No” in S14), the display controlling section 129 proceeds to S16. In contrast, in a case where the suggestion information corresponds to the action involving thinking (“Yes” in S14), agent attribute information is added to an agent expression component (in the above, the component for specifying an agent model) (S15), and the process proceeds to S16.

Further, in a case where the suggestion information does not correspond to the perceptual action (“No” in S16), the display controlling section 129 proceeds to S18. In contrast, in a case where the suggestion information corresponds to the perceptual action (“Yes” in S16), a perception type is added to the agent expression component (the component for specifying the agent model) (S17), and the process proceeds to S18. The display controlling section 129 determines the agent model on the basis of the expression component of the agent (e.g., the agent model corresponding to the expression component) (S18).

It is to be noted that in a case where there is a plurality of agent expression components, agent models corresponding to the respective expression components may be determined. For example, if the perception type “vision” and the perception type “smell” are expression components, the agent model “humanoid agent” corresponding to the perception type “vision” and the agent “dog-shaped agent” corresponding to the perception type “smell” may be determined. Alternatively, if the user attribute information “event participant” and the perception type “vision” are expression components, the agent model “humanoid agent wearing clothes of an event participant” corresponding to the user attribute information “event participant” and the agent model “humanoid agent” corresponding to the perception type “vision” may be determined.

Proceeding to FIG. 17, the display controlling section 129 controls the display unit 150 to display the agent using the determined agent model (S21). In a case where a state in which the user notices the agent is not detected and in a case where a process termination instruction is not detected (“No” in S22), the display controlling section 129 shifts the operation to S22. In contrast, in a case where the state in which the user notices the agent is detected or in a case where the process termination instruction is detected (“Yes” in S22), the display controlling section 129 controls the display unit 150 to display the agent that performs an action based on the presentation information (S23).

It is to be noted that the display controlling section 129 may cause the agent to perform a predetermined action that is likely to attract an attention of the user until the state in which the user notices the agent is detected. Whether the user notices the agent (whether the user is looking at the agent) may be determined on the basis of whether the line of sight or the face of the user is directed to the agent in the field of view of the user, or on the basis of a change in biological information of the user. Further, the display controlling section 129 may control the display unit 150 to uniformly display the agent that performs the action based on the presentation information regardless of whether or not the user notices the agent.

Alternatively, in the case where the suggestion information corresponds to the action involving thinking, the display controlling section 129 may control the display unit 150 to display the agent that performs the action based on the presentation information if the state in which the user notices the agent is detected. In contrast, in the case where the suggestion information corresponds to the perceptual action, the display controlling section 129 may control the display unit 150 to uniformly display the agent that performs the action based on the presentation information, regardless of whether or not the user notices the agent. Further, the process termination instruction may be detected on the basis of the fact that the attention of the user is removed from the agent.

In a case where the user does not perform the action in accordance with the action of the agent, in a case where the user does not ignore the agent, and in a case where the process termination instruction is not detected (“No” in S24), the display controlling section 129 shifts the operation to S24. Whether or not the user has ignored the agent may be determined on the basis of whether or not the line of sight or the face of the user is directed to a place other than the agent in the field of view of the user, or on the basis of a change in the biological information of the user. Alternatively, the display controlling section 129 may regard that the user has ignored the agent if the user has not acted in accordance with the action of the agent for more than a predetermined time period.

In contrast, in a case where the user performs the action in accordance with the action of the agent, in a case where the user ignores the agent, or in a case where the process termination instruction is detected (“Yes” in S24), the display controlling section 129 performs the display termination process (S25). It is to be noted that, in the display termination process, the display controlling section 129 may delete the agent from the field of view of the user, may stop the agent from performing the action based on a suggestion state, or may cause the agent to continue an action (default action) differing from the action based on the suggestion state.

The example operation of the information processing apparatus 10 has been described above.

### 1.3.4. Various Modification Examples

As described above, the control of the agent according to an embodiment of the present disclosure is performed. However, the control of the agent should not be limited to the above-described example. For example, in the above description, an example of causing the agent to perform the action involving thinking and an example of causing the agent to perform the perceptual action have been described. However, the example of causing the agent to perform the action involving thinking and the example of causing the agent to perform the perceptual action should not be limited to the above-described examples. Hereinafter, the example of causing the agent to perform the action involving thinking and the example of causing the agent to perform the perceptual action will be further described.

First, the example of causing the agent to perform the action involving thinking will be described. For example, in a case where the context acquiring section 121 acquires that the user has reached a nearest station of an event venue, the display controlling section 129 may control the display unit 150 to display an agent (humanoid agent, etc.) having the same or similar appearance (e.g., clothes, belongings, etc.) as the user. By visually recognizing such an agent, the user is able to understand that there is the event venue where he/she is heading.

At this time, the user can understand what it is better to obtain before reaching the event venue by visually recognizing the belongings of the agent (humanoid agent, etc.). Further, the user can understand what it is better to get by visually recognizing the agent (humanoid agent, etc.) who is shopping, for example. Alternatively, the user can understand that a rest space to which he/she is heading may be full by visually recognizing such an agent.

Further, for example, in a case where a predetermined context is acquired by the context acquiring section 121, the display controlling section 129 may cause the agent accompanying the user to perform a predetermined action. For example, in a case where state information indicating the tiredness state of the user is acquired by the context acquiring section 121, the display controlling section 129 may cause the agent to perform a motion of being tired. By visually recognizing such an agent, the user understands that it is better for him/her to take a rest.

Alternatively, in a case where the context acquiring section 121 acquires that the user has walked more than a predetermined distance or a predetermined time period has elapsed since last hydration (e.g., on the basis of an image in which the user is captured), the display controlling section 129 may cause the agent to be hydrated. By visually recognizing such an agent, the user can understand that it is better for him/her to be hydrated.

Further, in a case where a predetermined context is acquired by the context acquiring section 121, the display controlling section 129 may cause the agent to perform a predetermined action. For example, in a case where the context acquiring section 121 acquires that another person is looking at the user's chest, (e.g., on the basis of an image in which the other person is captured), the display controlling section 129 may cause the agent to look at the user's chest. Alternatively, in a case where the context acquiring section 121 acquires that user has buttoned mistakenly (e.g., on the basis of an image in which the user is captured), the display controlling section 129 may cause the agent to look at the user's chest. By visually recognizing such an agent, the user can check his or her chest and notice the mistake of the buttons.

For example, in a case where the context acquiring section 121 acquires that another person is looking at the user's foot (e.g., on the basis of an image in which the other person is captured), the display controlling section 129 may cause the agent to look at the user's foot. Alternatively, in a case where the context acquiring section 121 acquires that the user's shoelace is untied (e.g., on the basis of an image in which the user is captured), the display controlling section 129 may cause the agent to look at the user's foot. By visually recognizing such an agent, the user can check his/her foot and notice that the shoelace is untied.

For example, in a case where the context acquiring section 121 acquires that another person is watching the user (e.g., watching the user with an unpleasant expression) while the user is listening to music on an earphone (e.g., on the basis of an image in which the other person is captured), the display controlling section 129 may cause the agent to perform a predetermined action indicating noise leakage (e.g., an ear-blocking action, an action of listening to music while leaking noise and annoying the surrounding people, etc.). By visually recognizing such an agent, the user can check the loudness of the sound leaking from the earphone or the headphone to the surroundings to understand the noise leakage (to take care not to increase the sound volume too much).

Alternatively, in a case where the context acquiring section 121 acquires that a real object (e.g., a person, a bicycle, an automobile, etc.) is approaching the user (e.g., on the basis of an image in which the user is captured), the display controlling section 129 may change the agent to direct the line of sight to the real object (e.g., a person, a bicycle, an automobile, etc.). By visually recognizing such an agent, the user can understand that it is better to check the safety of the surroundings.

For example, in a case where the context acquiring section 121 acquires a shampoo smell (e.g., on the basis of a smell detected by a smell sensor), the display controlling section 129 may cause the agent to perform a predetermined action (e.g., an sniffing action, etc.) that pays attention to the smell. By visually recognizing such an agent, the user can understand that an acquaintance has changed shampoos.

### 2. Example Hardware Configuration

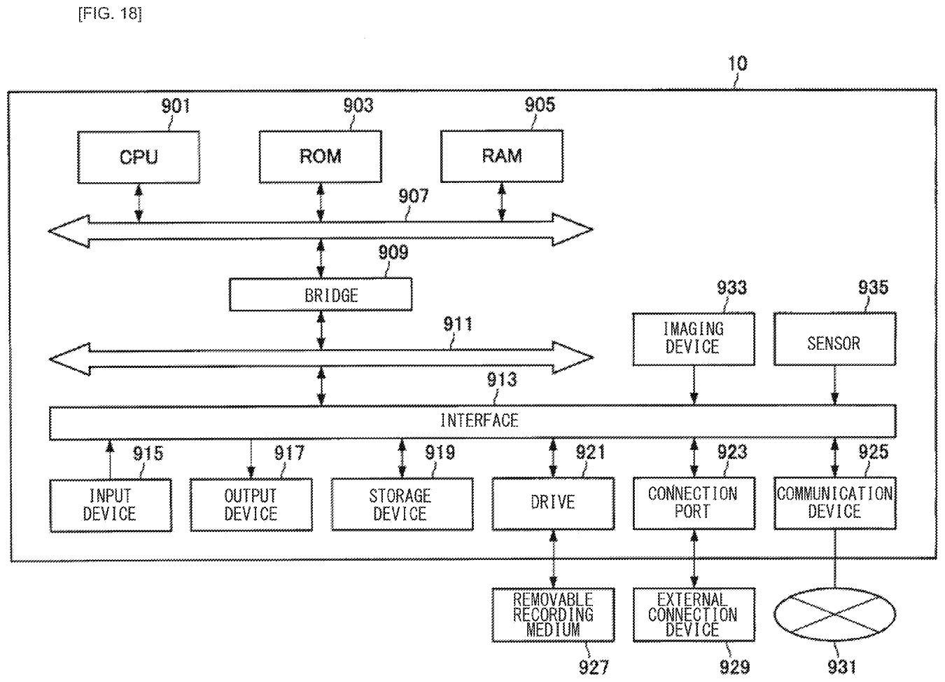

Next, an example hardware configuration of the information processing apparatus 10 according to an embodiment of the present disclosure is described with reference to FIG. 18. FIG. 18 is a block diagram illustrating the example hardware configuration of the information processing apparatus 10 according to the embodiment of the present disclosure.

As illustrated in FIG. 18, the information processing apparatus 10 includes a central processing unit (CPU) 901, a read only memory (ROM) 903, and a random access memory (RAM) 905. Additionally, the information processing apparatus 10 includes a host bus 907, a bridge 909, an external bus 911, an interface 913, an input device 915, an output device 917, a storage device 919, a drive 921, a connection port 923, and a communication device 925. The information processing apparatus further includes an imaging device 933 and a sensor 935. The information processing apparatus 10 may include a processing circuit, which is referred to as a digital signal processor (DSP) or an application specific integrated circuit (ASIC), in place of or in addition to the CPU 901.

The CPU 901 functions as a calculation processing device and a control device. The CPU 901 controls an entire or partial operation of the information processing apparatus 10 in accordance with various programs stored in the ROM 903, the RAM 905, the storage device 919, or a removable recording medium 927. The ROM 903 stores programs and calculation parameters to be used by the CPU 901. The RAM 905 temporarily stores programs to be used for execution of the CPU 901 or parameters to be appropriately changed during the execution. The CPU 901, the ROM 903, and the RAM 905 are mutually coupled via the host bus 907 including an internal bus such as a CPU bus. Further, the host bus 907 is coupled to the external bus 911, which may be a peripheral component interconnect/interface (PCI) bus, via the bridge 909.

The input device 915 is a device operated by the user. Examples of the input device 915 include a mouse, a keyboard, a touch panel, a button, a switch, a lever, and the like. The input device 915 may include a microphone that detects a voice of the user. For example, the input device 915 may be a remote control device using infrared light or other electric waves, or an external connection device 929, such as a mobile phone, that operates in accordance with the operation of the information processing apparatus 10. The input device 915 includes an input control circuit that generates an input signal on the basis of information inputted by the user and outputs the input signal to the CPU 901. The user inputs various data or provides an instruction about a process operation to the information processing apparatus 10 by operating the input device 915. Additionally, the imaging device 933 described below may function as an input device by capturing an image of a motion of a hand of the user or a finger of the user. At this time, a pointing position may be determined on the basis of the motion of the hand or the orientation of the finger.

The output device 917 is a device visually or audibly notifies the user of the acquired information. For example, the output device 917 may be a display device, such as a liquid crystal display (LCD), a plasma display panel (PDP), an organic electro-luminescence (EL) display, or a projector, a hologram display device, a sound output device, such as a speaker or a headphone, or a printing device. The output device 917 outputs a result obtained through the process by the information processing apparatus 10 as a visual image such as texts or pictures, or a sound such as a voice or an audio sound. Additionally, the output device 917 may include a light for illuminating the surroundings.

The storage device 919 is a data storage device serving as a part of a storage unit of the information processing apparatus 10. For example, the storage device 919 includes a magnetic storage device such as a hard disk drive (HDD), a semiconductor storage device, an optical storage device, or a magneto-optical storage device. The storage device 919 stores programs to be executed by the CPU 901, various data, and various data acquired from the outside.

The drive 921 is a reader-writer for the removable recording medium 927 which may be a magnetic disk, an optical disk, a magneto-optical disk, or a semiconductor memory. The drive 921 is incorporated in the information processing apparatus 10 or is an external drive of the information processing apparatus 10. The drive 921 reads information stored in the removable recording medium 927 mounted thereon and outputs the information to the RAM 905. Additionally, the drive 921 writes records on the removable recording medium 927 mounted thereon.

The connection port 923 is a port for directly coupling a device to the information processing apparatus 10. For example, the connection port 923 may be a universal serial bus (USB) port, an IEEE 1394 port, or a small computer system interface (SCSI) port. Alternatively, the connection port 923 may be an RS-232C port, an optical audio terminal, or a high-definition multimedia interface (HDMI) (registered trademark) port. Coupling the external connection device 929 to the connection port 923 may cause the information processing apparatus 10 and the external connection device 929 to interchange various data therebetween.

The communication device 925 is a communication interface including a communication device for connection to a communication network 931, for example. For instance, the communication device 925 may be a communication card for a wired or wireless local area network (LAN), Bluetooth (registered trademark), or a wireless USB (WUSB). Alternatively, the communication device 925 may be an optical communication router, a router for an asymmetric digital subscriber line (ADSL), or a modem for various communications. For example, the communication device 925 sends/receives a signal to/from the internet or another communication device using a predetermined protocol such as TCP/PI. Additionally, the communication network 931 coupled to the communication device 925 is a wired or wirelessly connected network, such as the internet, home LAN, infrared communication, radio-wave communication, or satellite communication.

For example, the imaging device 933 is a device that images the real space using an imaging element, such as a charge coupled device (CCD) or a complementary metal oxide semiconductor (CMOS), and various members including a lens for controlling imaging of a subject image on the imaging element, and generates a captured image. The imaging device 933 may capture a still image or a moving image.

For example, the sensor 935 includes various sensors, such as a ranging sensor, an acceleration sensor, a gyroscopic sensor, a geomagnetic sensor, an optical sensor, or a sound sensor. The sensor 935 acquires information related to the state of the information processing apparatus 10 itself, such as the attitude of a casing of the information processing apparatus 10, and information related to the surrounding environment around the information processing apparatus 10, such as the brightness and noises in the surroundings of the information processing apparatus 10. Additionally, the sensor 935 may include a global positioning system (GPS) sensor that receives a GPS signal and measures the latitude, longitude, and altitude of the device.

### 3. Conclusion

As described above, according to the embodiments of the present disclosure, the information processing apparatus is provided that includes an information processing apparatus including an action information acquiring section that acquires action information of a user, a suggestion information acquiring section that acquires, on a basis of the action information, suggestion information for the user related to a surrounding environment of the user based on a timing of acquiring the action information, and a display controlling section that controls, on a basis of the suggestion information, a display device to display an avatar object that performs an action based on the suggestion information in a field of view of the user. According to the configuration, it is possible to make a suggestion to the user while reducing discomfort given to the user.

Although some preferred embodiments of the present disclosure have been described in detail above with reference to the accompanying drawings, the technical scope of the present disclosure should not be limited to such examples. It is clear that those having ordinary knowledge in the art in the technical field of the present disclosure will easily arrive at various alterations or modifications within a scope of the technical idea described in the claims, and it is understood that these alternations or modifications naturally belong to the technical scope of the present disclosure.

For example, programs may be made that cause the hardware, such as the CPU, the ROM, or the RAM, incorporated in the computer to achieve functions substantially the same as the functions of the control unit 120 described above. Additionally, a computer-readable recording medium that stores these programs may be provided.

The position of each of the components are not particularly limited as long as the above-described operations of the information processing apparatus 10 are achieved, for example. A part or entire process performed by each of the components in the information processing apparatus 10 may be performed by a server apparatus (not illustrated). As a specific example, some or all blocks of the control unit 120 in the information processing apparatus 10 may exist in the server apparatus (not illustrated). For example, some or all of the context acquiring section 121, the suggestion information acquiring section 122, the environment information acquiring section 123, the attribute information acquiring section 124, and the display controlling section 129 in the information processing apparatus 10 may exist in the server apparatus (not illustrated).

Further, the effects described herein are merely illustrative or exemplary, and are not limitative. That is, the technique according to the present disclosure may achieve, in addition to or in place of the above effects, other effects that are obvious to those skilled in the art from the description of the present specification.

It is to be noted that the following configurations also belong to the technical scope of the present disclosure.

(1)

An information processing apparatus including:

an action information acquiring section that acquires action information of a user;

a suggestion information acquiring section that acquires, on a basis of the action information, suggestion information for the user related to a surrounding environment of the user based on a timing of acquiring the action information; and

a display controlling section that controls, on a basis of the suggestion information, a display device to display an avatar object that performs an action based on the suggestion information in a field of view of the user.

(2)

The information processing apparatus according to (1), further including

an attribute information acquiring section that acquires attribute information of the user, in which

the display controlling section controls the display device to display the avatar object corresponding to the attribute information.

(3)

The information processing apparatus according to (2), in which the attribute information of the user includes sex information.

(4)

The information processing apparatus according to (2) or (3), in which the attribute information of the user includes clothes of the user.

(5)

The information processing apparatus according to any one of (2) to (4), in which the display controlling section controls the display device to display the avatar object corresponding to attribute information that is substantially identical to the attribute information of the user.

(6)

The information processing apparatus according to any one of (1) to (5), in which the display controlling section controls the display device to display the avatar object that performs a perceptual action with respect to the surrounding environment related to at least one of vision, taste, smell, hearing, or touch.

(7)

The information processing apparatus according to (6), in which the display controlling section controls the display device to change a direction of a line of sight of the avatar object to a direction of a real object included in the surrounding environment.

(8)

The information processing apparatus according to (6), in which the display controlling section controls the display device to change a direction of a nose of the avatar object to a direction of smell particles included in the surrounding environment.

(9)

The information processing apparatus according to (6), in which the display controlling section controls the display device to bend an ear of the avatar object to a sound included in the surrounding environment.

(10)

The information processing apparatus according to any one of (1) to (5), in which

the surrounding environment includes weather of an area around the user, and

the display controlling section controls the display device to display the avatar object that performs an action related to the weather.

(11)

The information processing apparatus according to (10), in which the action related to the weather includes an action related to purchasing of rain apparel.

(12)

The information processing apparatus according to any one of (1) to (5), in which the display controlling section controls the display device to display the avatar object that performs a purchase action related to the surrounding environment.

(13)

The information processing apparatus according to (12), in which the display controlling section controls the display device to place the avatar object in front of a store in which it is possible to perform the purchase action.

(14)

The information processing apparatus according to any one of (1) to (5), in which the action information includes state information indicating a tiredness state of the user, and the display controlling section controls the display device to display the avatar object that performs a recovery action based on the state information.

(15)

The information processing apparatus according to (14), in which the recovery action includes at least one of an action related to a break or an action related to hydration.

(16)

The information processing apparatus according to any one of (1) to (5), in which

the action information is determined on a basis of a negative reaction of a person with respect to the user, the person being in the surrounding environment based on a result obtained by recognizing an image of the surrounding environment, and

the display controlling section controls the display device to display the avatar object that reproduces the negative reaction.

(17)

The information processing apparatus according to (16), in which the negative reaction includes that the person who is in the surrounding environment directs a line of sight to the user.

(18)

The information processing apparatus according to any one of (1) to (17), in which the information processing apparatus includes a head mounted display (HMD).

(19)

An information processing method including:

acquiring action information of a user;

acquiring, on a basis of the action information, suggestion information for the user related to a surrounding environment of the user based on a timing of acquiring the action information; and

controlling, on a basis of the suggestion information, a display device to display an avatar object that performs an action based on the suggestion information in a field of view of the user.

(20)

A program causing a computer to function as an information processing apparatus, the information processing apparatus including

an action information acquiring section that acquires action information of a user,

a suggestion information acquiring section that acquires, on a basis of the action information, suggestion information for the user related to a surrounding environment of the user based on a timing of acquiring the action information, and

a display controlling section that controls, on a basis of the suggestion information, a display device to display an avatar object that performs an action based on the suggestion information in a field of view of the user.

### REFERENCE SIGNS LIST

10: information processing apparatus
110: sensor unit
120: control unit
121: context acquiring section
122: suggestion information acquiring section
123: environment information acquiring section
124: attribute information acquiring section
129: display controlling section
130: storage unit
131: suggestion definition information
132: agent definition information
133: agent model information corresponding to action involving thinking
134: agent model information corresponding to perceptual action
135: map information
140: communication unit
150: display unit
20: user
31: real object
32: agent
33: virtual object
41: comment
50: field of view

1. An information processing apparatus comprising:
an action information acquiring section that acquires action information of a user;
a suggestion information acquiring section that acquires, on a basis of the action information, suggestion information for the user related to a surrounding environment of the user based on a timing of acquiring the action information; and
a display controlling section that controls, on a basis of the suggestion information, a display device to display an avatar object that performs an action based on the suggestion information in a field of view of the user.

2. The information processing apparatus according to claim 1, further comprising
an attribute information acquiring section that acquires attribute information of the user, wherein
the display controlling section controls the display device to display the avatar object corresponding to the attribute information.

3. The information processing apparatus according to claim 2, wherein the attribute information of the user includes sex information.

4. The information processing apparatus according to claim 2, wherein the attribute information of the user includes clothes of the user.

5. The information processing apparatus according to claim 2, wherein the display controlling section controls the display device to display the avatar object corresponding to attribute information that is substantially identical to the attribute information of the user.

6. The information processing apparatus according to claim 1, wherein the display controlling section controls the display device to display the avatar object that performs a perceptual action with respect to the surrounding environment related to at least one of vision, taste, smell, hearing, or touch.

7. The information processing apparatus according to claim 6, wherein the display controlling section controls the display device to change a direction of a line of sight of the avatar object to a direction of a real object included in the surrounding environment.

8. The information processing apparatus according to claim 6, wherein the display controlling section controls the display device to change a direction of a nose of the avatar object to a direction of smell particles included in the surrounding environment.

9. The information processing apparatus according to claim 6, wherein the display controlling section controls the display device to bend an ear of the avatar object to a sound included in the surrounding environment.

10. The information processing apparatus according to claim 1, wherein
the surrounding environment includes weather of an area around the user, and
the display controlling section controls the display device to display the avatar object that performs an action related to the weather.

11. The information processing apparatus according to claim 10, wherein the action related to the weather includes an action related to purchasing of rain apparel.

12. The information processing apparatus according to claim 1, wherein the display controlling section controls the display device to display the avatar object that performs a purchase action related to the surrounding environment.

13. The information processing apparatus according to claim 12, wherein the display controlling section controls the display device to place the avatar object in front of a store in which it is possible to perform the purchase action.

14. The information processing apparatus according to claim 1, wherein
the action information includes state information indicating a tiredness state of the user, and
the display controlling section controls the display device to display the avatar object that performs a recovery action based on the state information.

15. The information processing apparatus according to claim 14, wherein the recovery action includes at least one of an action related to a break or an action related to hydration.

16. The information processing apparatus according to claim 1, wherein
the action information is determined on a basis of a negative reaction of a person with respect to the user, the person being in the surrounding environment based on a result obtained by recognizing an image of the surrounding environment, and
the display controlling section controls the display device to display the avatar object that reproduces the negative reaction.

17. The information processing apparatus according to claim 16, wherein the negative reaction includes that the person who is in the surrounding environment directs a line of sight to the user.

18. The information processing apparatus according to claim 1, wherein the information processing apparatus includes a head mounted display (HMD).

19. An information processing method comprising:
acquiring action information of a user;
acquiring, on a basis of the action information, suggestion information for the user related to a surrounding environment of the user based on a timing of acquiring the action information; and
controlling, on a basis of the suggestion information, a display device to display an avatar object that performs an action based on the suggestion information in a field of view of the user.

20. A program causing a computer to function as an information processing apparatus, the information processing apparatus comprising
an action information acquiring section that acquires action information of a user,
a suggestion information acquiring section that acquires, on a basis of the action information, suggestion information for the user related to a surrounding environment of the user based on a timing of acquiring the action information, and
a display controlling section that controls, on a basis of the suggestion information, a display device to display an avatar object that performs an action based on the suggestion information in a field of view of the user.
